(19) United States
(12) Patent Application Publication
(10) Pub. No.: US 2003/0111285 A1
(43) Pub. Date: Jun. 19, 2003

(54) Longitudinally installed power train and method of making a power train

(76) Inventors: Philip Gansloser, Amstetten (DE); Hartmut Nied, Waiblingen (DE); Rolf Schroeder, Stuttgart (DE); Guenter Woerner, Kernen (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/189,760

(22) Filed: Jul. 8, 2002

(30) Foreign Application Priority Data
Dec. 18, 2001 (DE) DE 101 62 337.2

(51) Int. Cl. B60K 17/34

(52) U.S. Cl. 180/233

(57) ABSTRACT

A longitudinally installed power train for all wheel drive motor vehicles is provided. First, configuring a side output drive for the front axle drive with a gear pair is proposed. Second, providing an articulated shaft of the side output drive with a joint is suggested, which is arranged inside a gear of the gear pairing.

### BACKGROUND AND SUMMARY OF THE INVENTION

This application claims the priority of German Patent Document DE 101 62 337.2, filed on Dec. 18, 2001, the disclosure of which is expressly incorporated by reference herein.

The invention relates to a longitudinally installed power train for a motor vehicle wherein, by way of a distributor gear unit, a drive torque is transmittable, firstly, to a rear axle and, secondly, to a front axle through an articulated shaft arranged at an angle to the longitudinal axis of the power train.

A longitudinally installed power train for an all wheel drive motor vehicle is already known from Bohner, Max: Motor Vehicle Engineering, 26^{th} Edition, Verlag Europa-Lehrmittel, 1999, p. 382, where by way of a distributor gear, a driving torque is transmittable first to a rear axle and secondly to a front axle through a shaft arranged at an angle toward the power train longitudinal axis.

Furthermore, German Patent Document DE 101 33 118.5 shows a longitudinally installed power train for a motor vehicle, where by a distributor gear, a driving torque is transmittable first to a rear axle and secondly to a front axle through a shaft arranged at an angle toward the power train longitudinal axis.

U.S. Pat. No. 4,289,213 shows a longitudinally installed power train for a motor vehicle where by a distributor gear, a driving torque is transmittable first to a rear axle and secondly to a front axle through a shaft arranged at an angle toward the power train longitudinal axis.

German Patent Document DE 199 04 960 C1 (and corresponding U.S. Pat. No. 6,290,605), of a different class, shows a field cutter with a universal joint which is arranged inside a gear.

An aspect of the invention is to create an efficiency-optimized longitudinally installed power train for an all wheel drive motor vehicle which can be incorporated into a narrow motor vehicle tunnel and nevertheless has no bending angle of the articulated shaft.

This aspect is accomplished in accordance with certain preferred embodiments of the invention through the longitudinally installed power train wherein the partial drive torque transmission from the distributor gear unit to the articulated shaft takes place through a drive pinion and an output pinion, and wherein a joint of the articulated shaft is arranged at least partially inside the output pinion.

According to certain preferred embodiments, the invention proceeds from a power drive for a motor vehicle, which in addition to a drive motor has a motor vehicle gear unit with a gear unit output shaft which points toward the rear of the vehicle in the installed state and which is connectable drive-wise with a pinion shaft of a front axle gear unit through an output shaft of a lateral output arranged swiveled and through an articulated joint of a front axle gear unit.

An advantage of certain preferred embodiments of the invention is that the bending angle of the articulated joint is kept very low since a great distance between the joints of the universal shaft is attained through the arrangement of a joint of this articulated shaft inside the output pinion of the lateral output. Through the small bending angle, advantages in efficiency are obtained in addition to advantages in installation in the vehicle tunnel, as the joint is less burdened with friction. The distance between the articulated joint and the gear unit housing is therewith advantageously determined by the slender outside diameter of the articulated joint. In this way, the previously mentioned distance is advantageously as small as possible. Advantageously, the relatively small vehicle tunnel of a rear-axle drive motor vehicle also suffices for the all wheel drive power train. Furthermore, advantageously the spur gears of the lateral output can be represented small in diameter. In this way, the lateral output is advantageously economical and light. Furthermore, an additional advantage of the arrangement of the joint inside the output pinion is that the articulated joint can be guided without a protective housing to the front axle gear unit, since the one joint inside the output pinion is at least partially protected from environmental influences.

An advantage of the configuration in accordance with another embodiment is that by using exclusively a gear stage which includes a drive pinion and output pinion, an especially favorable degree of efficiency is attained. In particular, by integration of the output pinion into a joint housing with the drive pinion and the distributor gear, losses are kept at the lowest level possible. Thus, a common lubrication and coolant circulation is used and the bearings

of the output pinion,

of the drive pinion and

the distributor gear

can be directly braced against one another so that a continuously exact gear engagement of the individual gearings is guaranteed.

Other embodiments show especially advantageous configurations of the invention in which the usual drive motor direction of rotation is considered so that the power train can be produced as an alternative so-called “add on principle” parallel to a rear wheel drive motor vehicle which goes along with cost advantages.

Furthermore, the configurations in accordance with the above have the advantage that the driven gear of the front axle gear unit, which is usually a spur bevel gear, is mounted very close on the drive motor and can be supported. Installation and efficiency advantages go along with this.

In accordance with yet other embodiments, at least one output pinion connected with the articulated joint for relieving the joint of the articulated joint can be swiveled toward the gear unit output shaft of the motor vehicle. In addition to the installation advantages, advantages in efficiency, especially on the joint, go along with this.

The further development of the power train in accordance with certain preferred embodiments, which have a certain axle angle on the front axle gear unit for their object, goes along with the advantages of diminishing size and with advantages in efficiency, since in these cases, the joint of the articulated joint is relieved in the region of the front axle gear unit.

These embodiments can be used with manual gearshifts, with automated gearshifts and especially with automatic transmissions. These are especially advantageously applicable with all wheel drives which have a motor vehicle gear unit, especially automatic transmission, designed for a rear wheel drive, that is, where the gear unit output shaft is connectable drive-wise with a pinion shaft of a rear axle gear unit, and the gear unit output shaft is connectable drive-wise according to the so-called “add on principle” through an output shaft of a side output drive and is connectable drive-wise through a articulated joint with a pinion shaft of a front axle gear unit. Despite a motor vehicle gear unit basically designed for a pure rear wheel drive, the articulated shaft can be guided with a small angle along a housing of the motor vehicle gear unit in the event of a small bending angle. Framework changes on a tunnel for all wheel variants of a motor vehicle outfitted with a pure rear wheel drive can be reduced to a minimum, or possibly be dispensed with.

Advantageously, either the pinion shaft of the front axle gear unit corresponding with the articulated shaft and/or the output shaft of the lateral output corresponding with the articulated shaft is constructed swiveled toward the gear unit output shaft, and to be sure vertically and/or horizontally in any given case. Instead of swiveling the pinion shaft of the front axle gear unit or the output shaft of the lateral output, providing swiveled intermediate shafts in further development, in accordance with certain preferred embodiments, is also conceivable.

In order to swivel the pinion shaft of the front axle gear unit and/or the output shaft of the lateral output, all constructions which appear appropriate to the specialist are usable.

In particular, however, a swiveled pinion shaft of the front axle gear unit can be attained in that either the entire front axle gear unit is arranged swiveled, owing to which an economical standard front axle gear unit can be used, or in that the front axle gear unit has a miter gear unit with an intersection angle unequal to 90°. In the latter case, side shafts of the motor vehicle can be constructed in a standard manner.

A swiveled output shaft of the side output drive can be advantageously attained in that the lateral drive is constructed as a miter gear unit with bevel gears which have rotation axes standing basically vertically in relation to one another, owing to which economical standard gears can be used.

In a refinement of the invention, the swiveled output shaft of the side output drive can also be attained in that the side output drive is constructed with at least three gears, whereby at least one gear is constructed conically. A side output drive constructed as a miter gear with axes of rotation standing basically perpendicular in relation to one another can be constructed as especially space saving.

If the motor vehicle gear unit possesses a gear unit housing with a tip-stretched bearing unit for lateral output, an additional intermediate housing between the motor vehicle drive unit and the lateral output can be avoided, and additional subassemblies, space, installation expense and costs can be saved.

Other objects, advantages and novel features of the present invention will become apparent from the following detailed description of the invention when considered in conjunction with the accompanying drawings.

### BRIEF DESCRIPTION OF THE DRAWINGS

FIG. 1 to FIG. 4 show four alternative embodiments in a sub-region, a schematic representation of a longitudinally installed power train for a motor vehicle;

FIG. 5 shows a bearing housing, which finds application with a power train in accordance with FIG. 3 or FIG. 4;

FIG. 6 shows a sub-region of the automatic transmission represented schematically in FIG. 3;

FIG. 7 shows a detailed side output drive which in particular can find use in connection with a power train in accordance with FIG. 3 or FIG. 4;

FIG. 8 shows a further embodiment in a detailed and cut away representation similar to the one from FIG. 7, whereby nonetheless instead of a universal joint another type of joint is used and a planetary differential gear unit is visible; and

FIG. 9 shows a further embodiment in a detailed and cut away representation similar to that from FIG. 8, whereby nonetheless a multiple disc clutch is used for the distributor gear unit instead of a planetary differential gear unit.

### DETAILED DESCRIPTION OF THE DRAWINGS

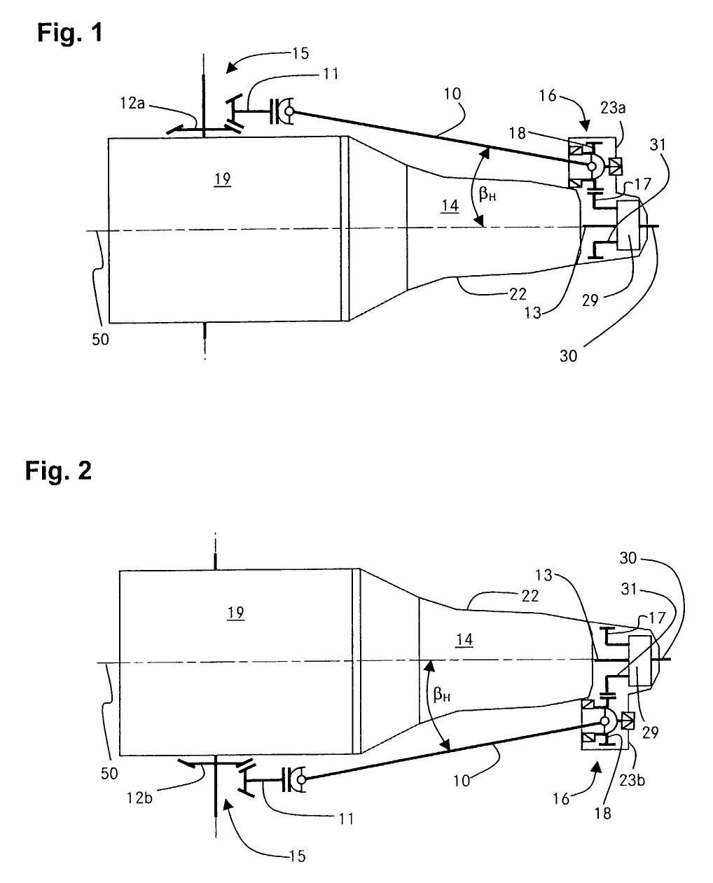

The common features of the alternative four embodiments in accordance with FIG. 1 to FIG. 4 are represented below.

FIG. 1 to FIG. 4 show in each case, in a sub-region, a schematic representation of a longitudinal installed power train for a motor vehicle which has a drive motor 19 and an automatic transmission 14 with a gear unit output shaft 13 pointing toward the rear of the motor vehicle. The power train is basically oriented along a power train longitudinal axis 50.

The automatic transmission 14 is basically designed for a pure rear wheel drive. The gear unit output shaft 13 is connected with an input shaft (not depicted in greater detail) of a rear axle drive unit in the installed state of automatic transmission 14.

The automatic transmission 14 possesses a gear unit housing 22 with a tip-stretched bearing housing 23a or 23b or 23c or 23d for a side output drive 16 so that the automatic transmission 14 is economically usable according to a so-called “add-on principle” for an all wheel variant.

With a variant of this type, the gear unit output shaft 13 (which is extended in comparison with the pure rear wheel drive variant) is connected through a distributor gear unit 29 and a rear wheel drive articulated shaft 30 with the pinion shaft of the rear axle gear unit such that a first part of the drive torque is transmitted to the rear axle drive unit. A second part of the drive torque is transmitted from the gear unit output shaft 13 over

the distributor gear unit 29,

a drive pinion 17,

an articulated shaft 10 of the side output drive 16 and

a bevel pinion shaft 11 of a front axle gear unit 15 to a front axle. Drive torques are distributable to the front axle gear unit 15 and the rear axle drive unit, and differences in rotational speed can be compensated for by means of the distributor gear unit 29.

The articulated shaft 10 of the side output drive 16 is horizontally pivoted about an angle of ca. 8° toward the gear unit output shaft 13 and indeed at all times in the direction toward the bevel pinion shaft 11 of the front axle gear unit 15. The articulated shaft 10 of the side output drive 16 is swiveled vertically by an angle of ca. 4° toward the gear unit output shaft 13, and to be sure in the direction toward the bevel pinion shaft 11 of the front axle gear unit 15. Here in the drawing only the angle β_{H} is visible in the horizontal.

The side output drive 16 is formed by two gears and indeed by a drive pinion 17 and an output pinion 18 meshing with this. The drive pinion 7 is connected torsion-resistant with a gear unit member of the distributor drive unit 29 by a hollow shaft 31. The drive pinion 18 is mounted by an engaged tapered roller bearing in x arrangement in the bearing housing 23a or 23b or 23c or 23d.

For producing the horizontal angle [symbol] _{H} and the vertical angle not represented in greater detail, the articulated shaft 10 is arranged radially articulated by a universal joint inside the output pinion 18. Furthermore, the articulated joint 10 is coupled flexibly in front-that is, on its other end-with a further universal joint to the bevel pinion shaft 11.

With the power train in accordance with FIG. 1, the drive pinion 17 and the output pinion 18 meshing with this are at all times constructed as spur gears. The articulated joint 10 is arranged on the side of the drive motor 19 lying to the right in the direction of travel. A spur bevel gear 12a of the front axle gear unit 15 is arranged on the side of the front axle gear unit 15 facing the drive motor 19 (that is on the left in the direction of travel).

With the power train in accordance with FIG. 2, the drive pinion 17 and the output pinion 18 meshing with this are in any given case constructed as spur gears. The articulated shaft 10 is arranged on the side of the drive motor 19 lying on the left side in the direction of travel. A spur bevel gear 12b of the front axle gear unit 15 is arranged on the side of the front axle gear unit 15 facing the drive motor 19, that is on the right in the direction of travel.

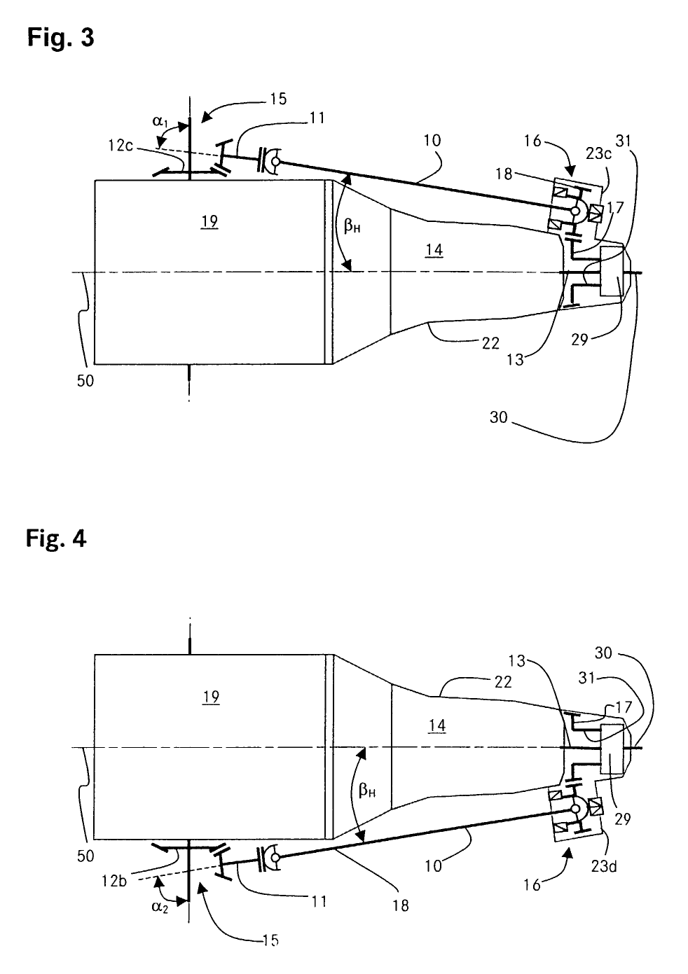

With the power train in accordance with FIG. 3, the drive pinion 17 and the output pinion 18 meshing with this is in any case constructed as a conical spur gear. An axis angle α₁ of these conical spur gears is moreover equal to the horizontal angle β_{H}. Furthermore, an axis angle α₁ of a spur bevel gear 12c and the bevel pinion shaft 11 about the angle β_{H} is smaller than 90° so that the bevel pinion 12c and the articulated shaft 10 lie in a common vertical plane. The articulated shaft 10 is arranged on the side lying to the right in the direction of travel of the drive motor 19. The spur bevel gear 12c of the front axle gear unit 15 is arranged on the side of the front axle gear unit 15 facing the drive motor 19, that is on the left side in the direction of travel.

With the power train in accordance with FIG. 4, the drive pinion 17 and the output pinion 18 meshing with this are in any given case constructed as conical spur gears. An axis angle of these conical spur gears is moreover equal to the horizontal angle β_{H}. Furthermore, an axis angle α₂ between spur bevel gear 12d and the bevel pinion shaft 11 about angle β_{H} is smaller than 90°, so that the bevel pinion shaft 12d and the articulated shaft 10 lie in a common vertical plane. The articulated shaft 10 is arranged on the side of the drive motor 19 lying to the left in the direction of travel. The spur bevel gear 12d of the front axle gear unit 15 is arranged on the side of the front axle gear unit 15 facing the drive motor 10, that is on the right in the direction of travel.

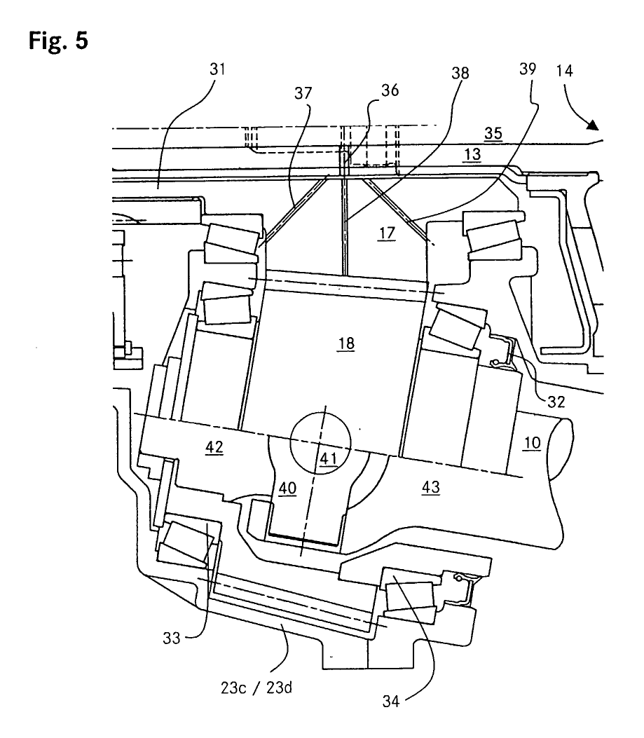

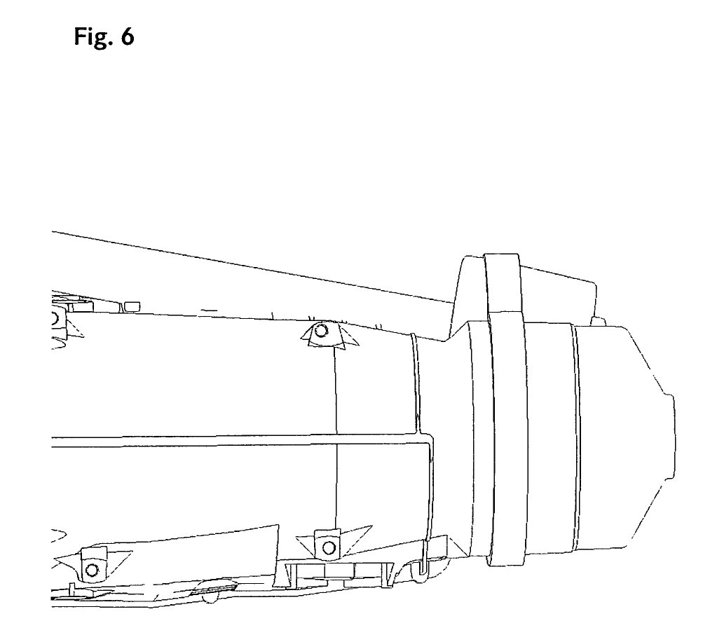

FIG. 5 depicts a bearing housing 23c or 23d in a cut away representation. The bearing housing 23c or 23d finds use in a power train in accordance with FIG. 3 or alternatively FIG. 4. The drive pinion 17 and the output pinion 18 meshing with this are in each case constructed as a conical bevel gear. An axis angle of these conical bevel gears is moreover equal to the horizontal angle β_{H}.

The gear unit output shaft 13 is configured as a hollow shaft and is arranged coaxial to the radial outer hollow shaft 31, whereby an annular channel remains between the two hollow shafts. The drive torque of the only partially visible automatic transmission 14 is fed into the distributor gear unit 29 which is not visible in FIG. 5 which distributes the drive torque on the one hand to the pinion shaft (not represented in greater detail) and on the other hand to the hollow shaft 31. The hollow shaft 31 is configured in one piece with the drive pinion 17 and mounted by a conical roller bearing in x arrangement in bearing housing 23c or 23d. The bearing housing 23c or 23d furthermore accommodates the conical roller bearing in x arrangement in which the output pinion 18 is mounted. The output pinion 18 has several shoulders on which for one the bearing internal rings 33, 34 of the conical roller bearings are coaxially installed and secondly a radial shaft sealing ring 32 lies. This radial shaft sealing 32 mounted in bearing housing 23c or 23d prevents a lubricant for lubricating

the two conical roller bearings in x arrangement and

the gear meshing between the two conical spur gears

from escaping from the bearing housing 23c or 23d.

For supplying lubricants, the gear unit output shaft 13 has a transverse bore hole 36 in addition to a central lubricant channel 35 by which lubricants and coolants are led from the central lubricant channel 35 into the annular channel. Component streams flow from this through supply bore holes 37, 38, 39 drilled ray-like into the spur gear of the drive pinion 17. These supply bore holes 37, 38, 39 run first to the two conical roller bearings of the conical roller bearing of the drive pinion 17 and secondly to the gear meshing between the two conical spur gears.

The universal joint is arranged radially inside with output pinion 18. Here axes of two bolts 40, 41 of the universal joint are arranged in the center. The two bolts 40, 41 form a system of axes. The one bolt 41 is pivoted in a joint half 42 of the universal joint and braced axially. This joint half is connected motion-resistant with the spur gear of the output pinion 18. The other bolt 41 is pivoted in another joint half 43 of the universal joint and braced axially. This joint half 43 is connected motion-resistant with articulated shaft 10. Consequently, the articulated shaft 10 projects out of the bearing housing 23c or 23d, against which the universal joint is arranged within the bearing housing 23c or 23d protected from direct environmental influences.

FIG. 6 shows a sub-region of the automatic transmission represented schematically in FIG. 3.

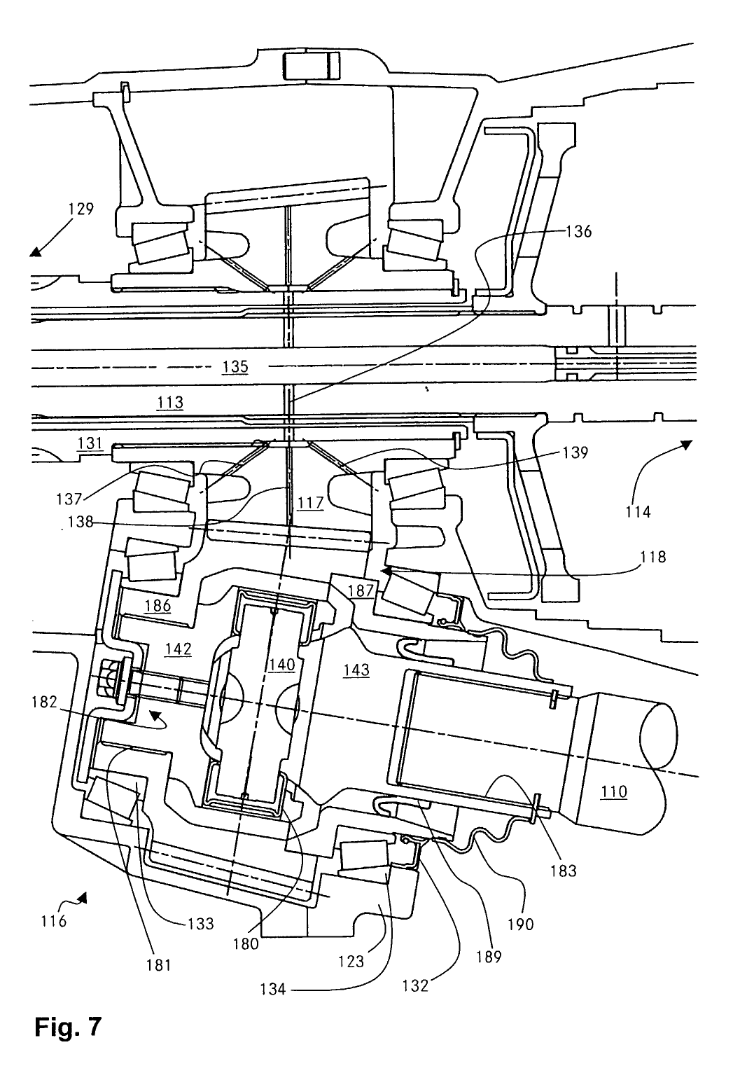

FIG. 7 shows a side output drive 116 with a bearing housing 123 in a cutaway drawing. The bearing housing can in particular find use in a power train in accordance with FIG. 3 or alternatively FIG. 4. A drive pinion 117 and an output pinion 118 meshing with this are in each case constructed as a conical spur gear. An axis angle of these conical spur gears is moreover equal to a horizontal angle β_{H} of an articulated shaft 110 of the side output drive 116.

A gear unit output shaft 113 is configured as a hollow shaft and arranged coaxially toward a radially outer hollow shaft 131, whereby an annular channel remains between the two hollow shafts. The drive torque of an only partly visible automatic transmission 114 is fed into a distributor gear unit 129 not visible in FIG. 7 which distributes the drive torque on the one hand to a pinion shaft of the rear axle gear unit (not represented in greater detail) and on the other hand to the hollow shaft 131. This hollow shaft 131 is configured in one piece with the drive pinion 117 and mounted in the bearing housing 123 by a conical roller bearing in x arrangement. The output pinion 118 includes two output pinion halves 186, 187 which have several shoulders on which for one the bearing inner rings 133, 134 of the conical roller bearings are mounted coaxially and secondly a radial shaft sealing 132 lies. This radial shaft sealing 132 inserted into the bearing housing 123 prevents lubricants for lubricating

the two conical roller bearings in x arrangement and

the gear meshing between the two conical spur gears

from escaping from the bearing housing.

For supplying lubricants, the gear unit output shaft 113 has a transverse bore hole 136 in addition to a central lubricant channel 135 by which lubricants and coolants are led from the central lubricant channel 135 into the annular channel. Component streams flow from this through supply bore holes 37, 38, 39 drilled ray-like into the spur gear of the drive pinion 17. These supply bore holes 137, 138, 139 run first to the two conical roller bearings of the conical roller bearing of the drive pinion 117 and secondly to the gear meshing between the two conical spur gears.

The universal joint is arranged radially inside the output pinion 118. Moreover the axes of a system of axes 140 of the universal joint are arranged centrally in the axial direction of the spur gear of the output pinion 118. The system of axes 140 is pivoted on the one hand by needle bearings (of which only the bearing cages 180 are visible) in a joint half 142 of the universal joint. Secondly, the system of axes 140 is pivoted in another joint half 143 of the universal joint.

The one joint half 142 is connected with the output pinion 118 torsion-resistant by way of a spline shaft connection 181 and axially fast by way of a screw bracing 182.

The other joint half 143 is connected with the articulated joint 110 torsion-resistant by way of a spline shaft connection 183 and axially fast by way of an axial retaining ring 184.

One end of an elastic bellows 190 is inverted through the other joint half 143 partially projecting out of the one output pinion half 187 and the bearing housing 123, the other end of which engages into an outer groove of the output pinion half 187 so that an interior space of the output pinion 118 and the universal joint accommodated in this or a grease packing provided for this are therewith protected from dirt and splashing water. Alternatively or additionally, a packing washer 189 can be provided for protection of the grease packing from dirt or splashing water. This packing washer 189 is braced between the interior of the output pinion half 187 and the exterior of the other joint half 143.

Through the shapes represented in the embodiments, the power train for an all wheel motor vehicle can be incorporated in a narrow vehicle tunnel in a space saving manner.

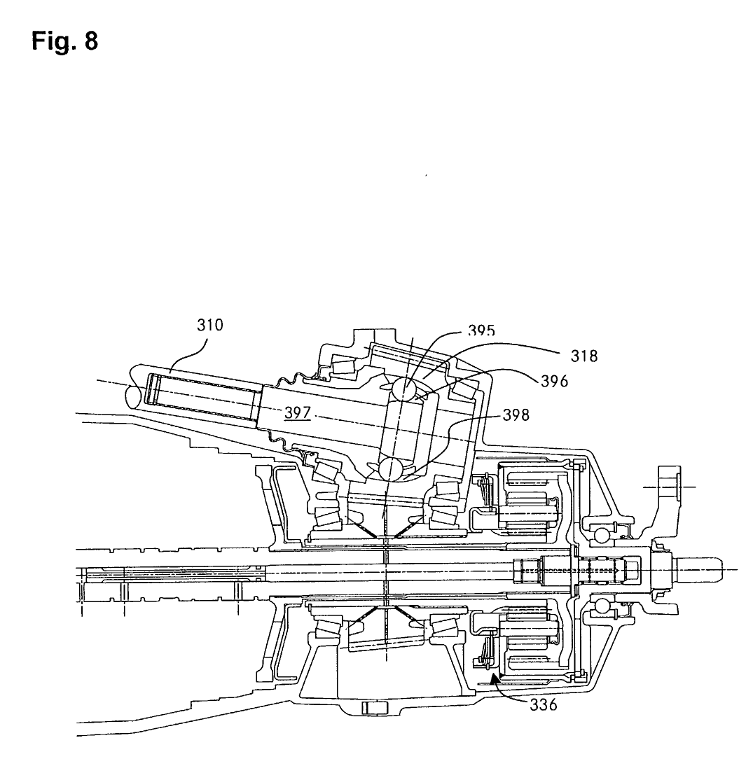

FIG. 8 shows a detailed gear unit device represented in cutaway similar to that from FIG. 7, whereby, however, instead of the universal joint, another type of joint is used. With this homokinetic type of joint, rounded groove paths 398 are worked into an output pinion 318. The groove paths 398 extend basically parallel to the axis of rotation of the output pinion 318 which is constructed as an externally geared hollow shaft. Corresponding to these groove paths 398, a joint element 397 connected with the articulated shaft 310 has accommodation grooves 396 for accommodating ball bearings 395. The drive torque for the front axis is transmitted through these ball bearings 395.

Furthermore, a distributor gear unit constructed as a planetary differential gear unit is visible in FIG. 8.

In addition, a temperature-dependent torque-damping friction clutch 336 is provided for damping load strokes. Such a temperature-dependent friction clutch 336 is described in the not previously published DE 101 11 257.2. A sun wheel and a satellite carrier of the differential gear unit are coupled with each other by friction clutch 336. The non-slip transmittable clutch torque of friction clutch 336 is so small that this automatically goes into friction slip operation in the event of torque thrusts and torque differences as they normally arise between the two differential parts with usual motor vehicle operation. The friction clutch 336 is provided with a temperature-dependent adjustment apparatus which diminishes the clutch closing pressure in a predetermined temperature range and therewith diminishes the transmittable clutch torque depending on the coupling temperature with increasing coupling temperature and increases with diminishing coupling temperature.

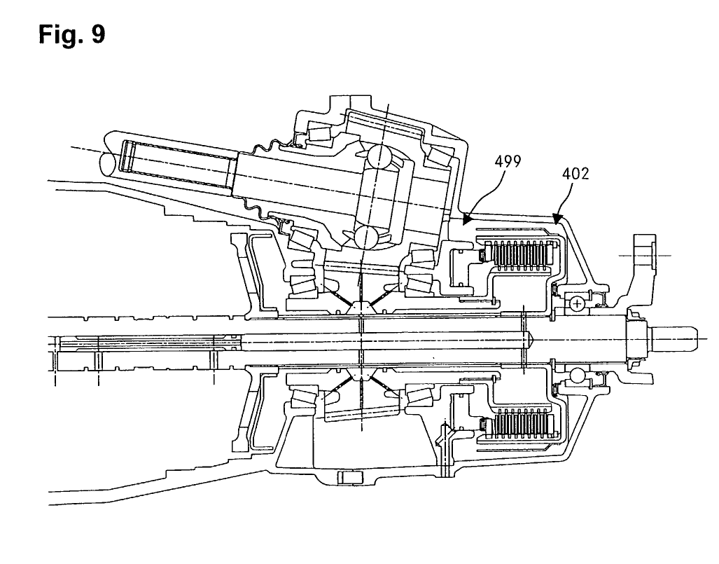

FIG. 9 shows a detailed gear unit device represented in section similar to that from FIG. 8, whereby, however, a multiple disc clutch 402 running in an oil bath is used instead of a differential gear unit.

Basically the use of all known homokinetic joints is possible in further alternative configurations. Thus, for example, double offset, ball bearing, receppa, tripod and annular joints offer themselves.

The horizontal angle β_{H} of the articulated shaft of the side output drive indicated at 8° in the first four alternative embodiments in accordance with FIG. 1 to FIG. 4 can in particular lie in a range from 8° to 9°. Furthermore, the vertical angle of the articulated shaft of the side output drive indicated in the first four alternative embodiments FIG. 1 to FIG. 4 at 4° can especially lie in a range from 4° to 5°.

The conical spur gears presented in the third and fourth alternative embodiments in accordance with FIG. 3 and FIG. 4 can also be configured as bevel gears.

The gear unit output shaft represented in the first four alternative embodiments in accordance with FIG. 1 to FIG. 4 and in FIG. 5 and FIG. 7 can also be configured as solid shafts.

The hollow shaft represented in the first four alternative embodiments in accordance with FIG. 1 to FIG. 4 and in FIG. 5 and FIG. 7 which is constructed in one piece with the drive pinion can also be executed in two parts.

The distributor gear unit can be incorporated into the gear unit or in addition be alternatively constructed as attachable components according to the “add-on principle.” The distributor gear unit can be represented with a fixed drive force distribution or alternatively with a front axle which can be cut in by means of a clutch.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. Longitudinally installed power train for a motor vehicle,
wherein, by way of a distributor gear unit a drive torque is transmittable, firstly to a rear axle, and secondly to a front axle through an articulated shaft arranged at an angle to a longitudinal axis of the power train,
wherein partial drive torque transmission from the distributor gear unit to the articulated shaft takes place through a drive pinion and an output pinion, and
wherein a joint of the articulated shaft is arranged at least partially inside the output pinion.

2. Longitudinally installed power train according to claim 1, wherein the partial drive torque transmission from the distributor gear unit to the articulated shaft takes place exclusively through a gear pairing including the drive pinion and the output pinion.

3. Longitudinally installed power train according to claim 2, wherein the articulated joint and a front axle gear unit are arranged on a side of the power train longitudinal axis lying to the right in a direction of travel and a gear of the front axle gear unit is arranged on a side of the front axle gear unit facing the power train longitudinal axis.

4. Longitudinally installed power train according to claim 2, wherein the articulated shaft and a front axle gear unit are arranged on a side of the power train longitudinal axis lying to the left in a direction of travel and a gear of the front axle gear unit is arranged on a side of the front axle gear unit facing the power train longitudinal axis.

5. Longitudinally installed power train according to claim 2, wherein the drive pinion and the output pinion are constructed as conical spur gears in each case.

6. Longitudinally installed power train according to claim 5, wherein an axis angle of the conical spur gears equals a horizontal angle β_{H} which is spread out between the power train longitudinal axis and an articulated shaft longitudinal axis of the articulated shaft.

7. Longitudinally installed power train according to claim 5, wherein the front axle gear unit is configured as a bevel pinion-spur bevel gear with an axis angle which is smaller than 90° by a horizontal angle, whereby the horizontal angle is spread out between the power train longitudinal axis and an articulated shaft longitudinal axis of the articulated shaft.

8. Longitudinally installed power train according to claim 6, wherein the front axis gear unit is configured as a bevel pinion-spur bevel gear with an axis angle which is smaller than 90° by a horizontal angle, whereby the horizontal angle is spread out between the power train longitudinal axis and the articulated shaft longitudinal axis of the articulated shaft.

9. Method of making power train for a vehicle, comprising:
longitudinally installing the power train;
arranging an articulated shaft at an angle to a longitudinal axis of the power train;
providing a distributor gear unit so that a drive torque is operatively transmittable, firstly, to a rear axle and, secondly, to a front axle through the articulated shaft, partial drive torque transmission from the distributor gear unit to the articulated shaft operatively taking place through a drive pinion and an output pinion, and
arranging a joint of the articulated shaft at least partially inside the output pinion.

10. Power train assembly for a vehicle, comprising:
a longitudinally arranged power train;
a distribution gear unit; and
an articulated shaft being arranged at an angle to a longitudinal axis of the power train;
wherein a drive torque is operatively transmittable to a rear axle and to a front axle through the articulated shaft via the distributor gear unit;
wherein partial drive torque transmission operatively takes place from the distributor gear unit to the articulated shaft via a drive pinion and an output pinion; and
wherein a joint of the articulated shaft is arranged at least partially inside the output pinion.
